(19) United States
(12) Patent Application Publication
(10) Pub. No.: US 2006/0182207 A1
(43) Pub. Date: Aug. 17, 2006

(54) Hybrid STBC receiver

(76) Inventors: In-Kyu Lee, Seoul (KR); Bong-Dae Choi, Seoul (KR); Chang-Kyung Sung, Seoul (KR)

Correspondence Address: MEREDITH & KEYHANI, PLLC, 330 MADISON AVE., 6TH FLOOR, NEW YORK, NY, 10017, US

(21) Appl. No.: 11/056,745

(22) Filed: Feb. 11, 2005

(51) Int. Cl. H04B 7/10; H04K 1/10

(52) U.S. Cl. 375/347; 375/260

(57) ABSTRACT

A receiver for a hybrid space time block codes (STBC) scheme using a nonlinear decision feedback (DFB) filter instead of a conventional linear filter which are used in the hybrid STBC scheme, that is, a combination of a spatial division multiplexing (SDM) scheme and a STBC scheme. In the receiver used for the STBC scheme, a previous-stage remaining signal is detected by using a well-known BLAST algorithm, and inter-symbol interference (ISI) is minimized by applying the previous-stage remaining signal to a current-stage signal, providing improved performance. The receiver used for the STBC scheme can be applied to a time varying channel fading environment as well as a quasi-static channel environment. According to the hybrid STBC scheme, a gain of about 3 dB can be obtained in channel environments having a frame error rate (FER) frequency efficiency of 2 and 3 Bps/Hz in the same condition by using a simulation.

### BACKGROUND OF THE INVENTION

The present invention relates to a receiver used for a hybrid space time block codes (STBC) scheme, and more particularly, to a receiver used for a hybrid STBC scheme using a nonlinear decision feedback (DFB) filter, where a previous-stage remaining signal is detected by using a well-known Bell-lab layered space time (BLAST) algorithm, and where inter-symbol interference (ISI) is minimized by applying the previous-stage remaining signal to a current-stage signal, so that performance can be stabilized and improved.

As demands for high speed data transmission in a next generation wireless communication system have increased, multiple antenna systems such as a multi-input multi-output (MIMO) system have been developed in order to increase capacity, throughput, and coverage of the wireless communication system. The MIMO systems are classified into systems implemented in accordance with a spatial division multiplexing (SDM) scheme and a space-time coding (STC) scheme.

The SDM scheme can increase the throughput of the system. However, there is a limitation that the number of receive antennas is larger than that of transmit antennas. The limitation results in increased capacity of the system, greater costs for downlink mobile stations, and added complexity to the system. Therefore, the SDM scheme is not generally used due to the aforementioned limitation.

The STC scheme can obtain diversity gains by using multiple transmit antennas in a fading channel environment, so that the STC scheme is suitable for a downlink mobile station, where a receive antenna diversity is hard to obtain. In the STC scheme, spatial diversity in a coding structure is used to improve link level. The STC scheme is classified into a space time trellis codes (STTC) scheme and a space time block codes (STBC) scheme.

According to the STTC scheme, good encoding and diversity gains can be obtained by using multiple antennas. However, in order to obtain a maximum diversity order, a complexity of a maximum likelihood (ML) decoder exponentially increases with respect to the number of transmit antennas and the transmission rate. Therefore, it is difficult to implement the encoder and decoder in accordance with the STTC scheme.

In order to overcome shortcomings of the STTC scheme, the aforementioned STBC scheme has been proposed. In the STBC, the number of receive antennas is not limited. Therefore, it is possible to obtain high performance even in a case where high transmission is required.

In the wireless communication system, multi-path fading and ISI phenomena are critical problems. The multi-path fading phenomenon means that the same signals passing through different paths are received by the receiver with time delay. The ISI phenomenon means that, as bit transmission rate increases, a portion of frequency components related to bit transition is delayed, and the delayed frequency components interfere with frequency components related to the following bits. Therefore, the ISI phenomenon limits maximum transmission rate.

The multi-path fading and ISI phenomena result in deterioration in performance of the whole system and distortion of signals. In order to solve the signal distortion problem, there has been proposed the aforementioned multiple antenna MIMO scheme. In addition, in order to solve the ISI problem, there has been proposed an orthogonal frequency division multiplexing (OFDM) scheme. Recently, hybrid schemes implemented by combining the two schemes have also been proposed.

One of the hybrid schemes is a hybrid STBC scheme implemented by combining the SDM and STBC schemes, which is disclosed in the ICC in (See “Transmit Diversity and Spatial Multiplexing in Four-Transmit-Antenna OFDM,” by Zhuang, F. W. Vook, S. Rouquette-Leveil, and K. Gosse in Proc. IEEE ICC '03., vol. 4, pp. 2316-2320, 2003).

Now, a hybrid STBC scheme implemented by combining the SDM and STBC schemes will be described with reference to FIG. 1. FIG. 1 is a block diagram showing a construction of a transmitter 100 used for the conventional hybrid STBC scheme. The transmitter 100 comprises a convolutional encoder 20, a bit interleaver 30, a mapper 40, a serial-to-parallel converter 50, and two STBC modules 60.

The two STBC modules 60 are implemented in accordance with an Alamouti STBC scheme. In each of the modules 60, the channel symbols are corrected with a minimum mean square error (MMSE) estimation using a complex linear superposition method, and then the corrected channel symbols are decoded. Each of the two STBC modules 60 is connected to two transmit antennas, so that transmission can be performed by four transmit antennas simultaneously.

Information symbols 10 are input to the convolutional encoder 20. The convolutional encoder 20 correlates previously-output bits to recover the symbols in order to correct error generated during the transmission. The bit interleaver 30 performs an interleaving process to randomize the concentrated errors. The symbols are converted into proper signals by the mapper 40. In turn, the signals (serial signals) are converted into parallel signals by the serial-to-parallel converter 50. The parallel signals are input to the two STBC modules 60. Finally, the four transmit antennas transmit the signals. Here, the convolutional encoder 20 or the bit interleaver 30 utilizes a well-known bit-interleaved coded modulation (BICM) process in order to ensure frequency diversity in the OFDM scheme.

In the conventional hybrid STBC scheme, the transmitter utilizes at least two transmit antennas, and the receiver utilizes a linear filter for detecting transmitted signals. In the conventional hybrid STBC scheme, a received signal can be represented as the following Equation 1. Here, the modulated symbol sₖ at the k-th subcarrier as [s^{k}₁ s^{k}₂ s^{k}₃ s^{k}₄]^{T} with (.)^{T} representing the transpose. Then the received signal y^{k} at the k-th subcarrier can be written as Equation 1.

$$\begin{matrix}{\underline{y}}^{k} = [ \begin{matrix}{\underline{y}}_{n}^{k} \\ {\underline{y}}_{n + 1}^{k *}\end{matrix} ] \\ = {H}^{k} {\underline{s}}^{k} + {\underline{n}}^{k} \\ = [ \begin{matrix}{h}_{1.1}^{k} & {h}_{2.1}^{k} & {h}_{3.1}^{k} & {h}_{4.1}^{k} \\ {h}_{1.2}^{k} & {h}_{2.2}^{k} & {h}_{3.2}^{k} & {h}_{4.2}^{k} \\ {h}_{2.1}^{k *} & - {h}_{1 , 1}^{k *} & {h}_{4.1}^{k *} & - {h}_{3.1}^{k *} \\ {h}_{2.2}^{k *} & - {h}_{1 , 2}^{k *} & {h}_{4.2}^{k *} & - {h}_{3.2}^{k *}\end{matrix} ] {\underline{s}}^{k} + {\underline{n}}^{k} \\ = [ \begin{matrix}{\underline{h}}_{1}^{k} & {\underline{h}}_{2}^{k} & {\underline{h}}_{3}^{k} & {\underline{h}}_{4}^{k} \\ {\underline{h}}_{2}^{k *} & - {\underline{h}}_{1}^{k *} & {\underline{h}}_{4}^{k *} & - {\underline{h}}_{3}^{k *}\end{matrix} ] {\underline{s}}^{k} + {\underline{n}}^{k} \\ = [ {H}_{1}^{k} {H}_{2}^{k} ] {\underline{s}}^{k} + {\underline{n}}^{k}\end{matrix} \qquad [ Equation 1 ]$$

Here, y^{k}ₙ represents the received signal vector of the k-th subcarrier at time n, h^{k}_{i,j} indicates the channel frequency response from the transmit antenna i to the receive antenna j at the k-th subcarrier and n^{k} is defined as [n^{k}ₙ n^{k}ₙ₊₁*]^{T}. Here, it is assumed that channel frequency responses are quasi-static for simplicity. Each noise component has variance σ²ₙ.

For the OFDM modulation, the received signal for each subcarrier can be independently modeled as Equation 1 . However, the channel frequency responses are correlated in frequency.

Assuming that there exist L taps in a channel profile, the channel frequency response from the transmit antenna i to the received antenna j can be modeled as Equation 2.

$${\hat{h}}_{i , j} ( t , τ ) = {\sum }_{n = 1}^{L} {\overline{h}}_{i , j} ( n , t ) δ ( τ - {τ}_{n} ) \qquad [ Equation 2 ]$$

Here, the channel coefficients h_{i,j}(n,t) are independent complex Gaussian distribution with zero mean, δ(T) denotes the Dirac delta function and Tₙ represents the propagation delay for the n-th channel tap. Assuming a quasi-static block fading channel model, we will omit the time index t for simplicity. With the OFDM modulation, the equivalent channel frequency response for each subcarrier is represented as the inverse Fourier transformed version of Equation 2. Then, the channel frequency response for the k-th subcarrier can be written as Equation 3.

$${h}_{i , j}^{k} = {\sum }_{n = 1}^{L} {\overline{h}}_{i , j} ( n ) {ⅇ}^{- 2 π k {τ}_{n} / FT} \qquad [ Equation 3 ]$$

Here, F denotes the number of subcarriers in the OFDM system. In the hybrid STBC scheme, ISI exists between two STBC blocks, and detection of s^{k} is performed by a linear equalizer. So the signal detection is carried out by multiplying the equalization matrix Wₖ,
ŝ^{k}=W^{k}y^{k} [Equation 4]

The filter matrix W^{k} is obtained with respect to the specific equalization method. Since the detection operation is independent with respect to subcarriers, we will omit the subcarrier index k for simplicity. For the Minimum Mean Square Error (MMSE) equalization, W can be computed as Equation 5.

$${W}_{MMSE} = \frac{1}{{d}_{1} {d}_{2} - ( δ - γ )} [ \begin{matrix}{d}_{2} I & - {H}_{1}^{H} {H}_{2} \\ - {H}_{2}^{H} {H}_{1} & {d}_{1} I\end{matrix} ] [ \begin{matrix}{H}_{1}^{H} \\ {H}_{2}^{H}\end{matrix} ] \qquad [ Equation 5 ]$$

where (.)^{H} denotes the Hermitian transpose and

$${d}_{1} = {\sum }_{i = 1}^{2} ( {‖ {h}_{1 , i} ‖}^{2} + {‖ {h}_{2 , i} ‖}^{2} ) + {σ}_{n}^{2}$$

$${d}_{2} = {\sum }_{i = 1}^{2} ( {‖ {h}_{3 , i} ‖}^{2} + {‖ {h}_{4 , i} ‖}^{2} ) + {σ}_{n}^{2}$$

$$δ = {\vert {\underline{h}}_{1}^{H} {\underline{h}}_{3} + {\underline{h}}_{2}^{T} {\underline{h}}_{4}^{*} \vert}^{2}$$

$$γ = {\vert {\underline{h}}_{1}^{H} {\underline{h}}_{4} + {\underline{h}}_{2}^{T} {\underline{h}}_{3}^{*} \vert}^{2} .$$

The zero forcing (ZF) solution for the hybrid STBC can be easily obtained by discarding σ²ₙ terms in d1 and d2. For time varying channels, the channel matrices H1 and H2 are not orthogonal any more. In this case, the equalization matrix should be obtained using the companion matrix property Equation 5, which results in somewhat different solutions from the above quasi-static case.

### SUMMARY OF THE INVENTION

In order to solve the aforementioned problems, an object of the present invention is to provide a hybrid Space time block codes (STBC) scheme using a nonlinear decision feedback (DFB) filter instead of a conventional linear filter which are used in the hybrid STBC scheme, that is, a combination of a spatial division multiplexing (SDM) scheme and a STBC scheme, where a previous-stage remaining signal is detected by using a well-known BLAST algorithm, and where inter-symbol interference (ISI) is minimized by applying the previous-stage remaining signal to a current-stage signal, so that performance can improved.

Another object of the present invention is to provide a hybrid STBC scheme which can be applied to a time varying channel fading environment as well as a quasi-static channel environment, and to provide a hybrid STBC scheme, which even in a channel environment having a high fading speed, the performance of the hybrid STBC scheme according to the present invention do not greatly deteriorate unlike the conventional hybrid STBC scheme, so that a stable performance can be obtained.

Still another object of the present invention is to a hybrid STBC scheme capable of obtaining a gain of about 3 dB in channel environments having a frame error rate (FER) frequency efficiency of 2 and 3 bps/Hz in the same condition. In order to achieve the aforementioned objects, according to an aspect of the present invention, there is provided a hybrid STBC scheme using a nonlinear DFB filter.

According to another aspect of the present invention, there is provided a hybrid STBC implemented by combining a SDM scheme and a STBC scheme, where a nonlinear DFB filter is used instead of a general linear filter.

This summary is not to be taken in a limiting sense, but is made merely for the purpose of illustrating the general principles of the invention, since the scope of the invention is best defined by the appended claims.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing a construction of a transmitter used for a conventional hybrid STBC scheme;

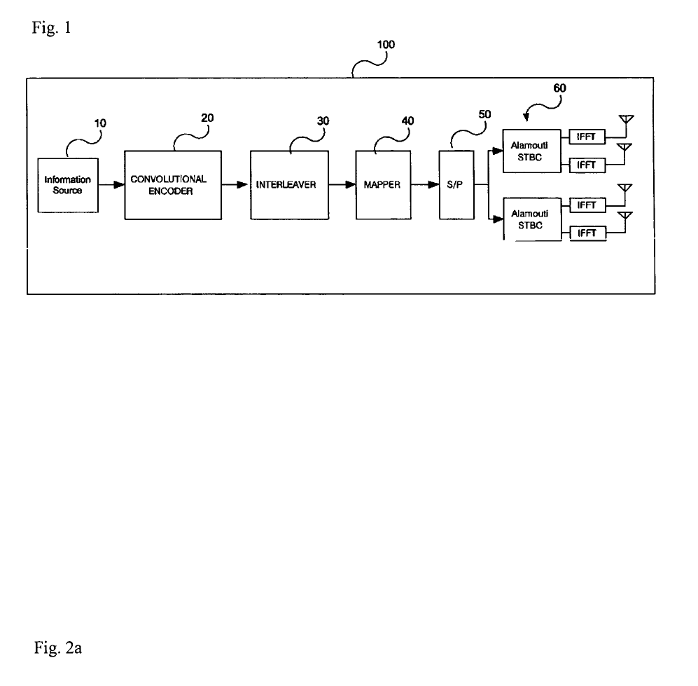

FIG. 2A is a graph showing a frame error rate (FER) obtained in a conventional hybrid STBC using a linear filter; and

FIG. 2B is a graph showing an FER obtained in the STBC scheme using a nonlinear DFB filter according the present invention.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. Like reference numerals in the drawings denote like elements.

In the hybrid STBC scheme according to the present invention, a construction of a receiver is the same as that of conventional one. A transmitter utilizes a nonlinear decision feedback (DFB) filter instead of a conventional linear filter.

In the hybrid STBC scheme according to the present invention, the channel matrix H has a full rank. The transmitted signal can be detected by using a BLAST (Bell-lab LAyered Space Time) algorithm. The nonlinear DFB filter obtains a signal vector by using symbols detected in previous stages, so that the ISI phenomenon can be eliminated.

In a general DFB filter, detection orders allocated to layers greatly affect performance. Since the detection order allocating algorithm is included in the BLAST algorithm, it is assumed that the received signals are arranged in an optimal order. When the i-th layer is detected, signals are can be represented by the following Equation 6.

$$\begin{matrix}\underline{{y}_{i}} = \underline{y} - {\hat{H}}_{i} {\hat{s}}_{i - 1} \\ = {H}_{i} {\underline{s}}_{i} + f ( \hat{e} ) + \underline{n}\end{matrix} \qquad [ Equation 6 ]$$

Here, f(·) denotes an error function generated by a previously-detected layer. As shown in Equation 6, since current-stage signals include remaining signals of previous-stage detected signal due to errors thereof, the remaining signals have to be taken into consideration. By considering the remaining signals, a filter for detecting current-layer signals are implemented in accordance with the following Equation 7.
W_{DFB}ⁱ=H*(HᵢHᵢ*+g(ê)+σₙ²I)⁻¹ [Equation 7]

In Equation 7, g(ê) denotes an autocorrelation matrix containing error components detected in the previous stages. In addition, an initial channel matrix Ho has the same value as that of the channel matrix in Equation 1. In addition, the n-th stage channel matrix Hi can be obtained by removing columns corresponding to the previously detected layers.

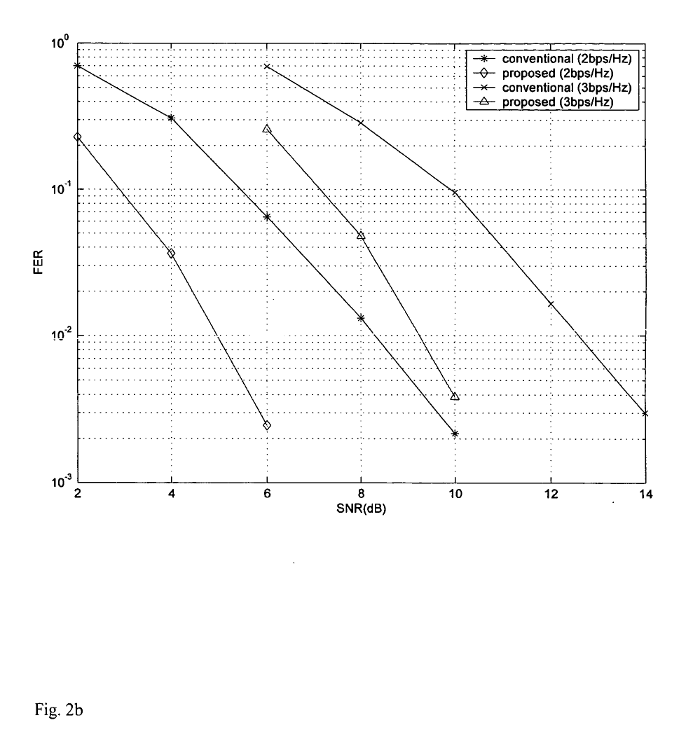

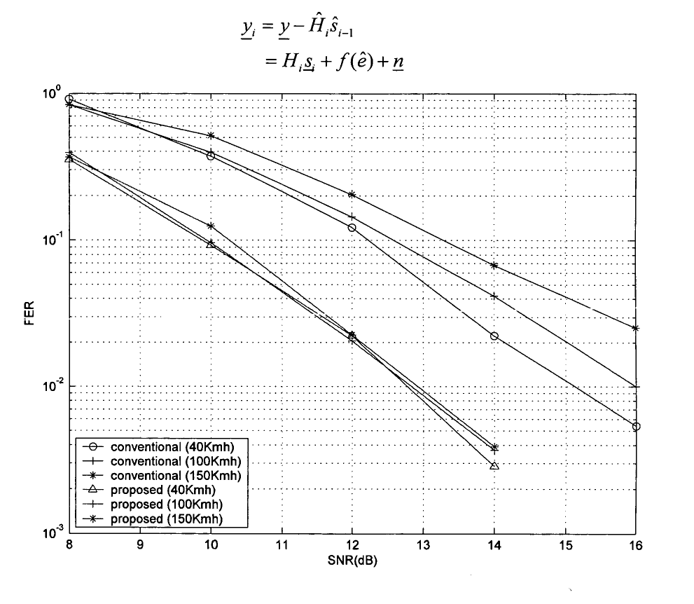

FIG. 2A is a graph showing a frame error rate (FER) obtained in a conventional hybrid STBC using a linear filter. FIG. 2B is a graph showing an FER obtained in the STBC scheme using a nonlinear DFB filter according the present invention.

Firstly, the graph in FIG. 2A is obtained by a simulation experiment on the assumptions: the OFDM system has 64 carriers; protection length between the adjacent carriers is 16 symbols; and a channel exponentially disappears during a time interval of 5 steps. In addition, the simulation results are FER obtained in two quasi-static channel environments having a spectral efficiency of 2 and 3 bps/Hz, respectively.

Referring to FIG. 2A, in a condition that the FER is 1%, the gain of the hybrid STBC scheme according to the present invention is by about 3 dB higher than that of the conventional hybrid STBC scheme.

On the other hand, the graph in FIG. 2B is obtained a simulation experiment on the same assumptions as those of FIG. 2B except that fading speed varies according to time. In addition, a carrier frequency f_{C} and a sampling frequency f_{S} are set to 5.8 GHz and 12. kHz, respectively. The simulation results are FER obtained in three channel environments having a channel fading speed of 40, 100, and 150 km/h, respectively.

Referring to FIG. 2B, in the conventional hybrid STBC scheme using the linear filter, as the channel fading speed increases, the channel frequency response does not satisfy the channel condition of the quasi-static channel environment in FIG. 2A. However, in the hybrid STBC scheme using the nonlinear DFB filter, event though the channel fading speed increases, the channel frequency response almost satisfies the channel condition of the quasi-static channel environment in FIG. 2A, so that the obtained simulation result is similar to that of the quasi-static channel environment in FIG. 2A.

In addition, it can be understood that, as the channel fading speed increases from 40 to 150 km/h in a condition of the FER of 1%, the hybrid STBC scheme according to the present invention.

According to the above simulation results, it can be understood, that in a channel environment having a time-varying fading speed such as a mobile communication environment, the hybrid STBC scheme using the nonlinear DFB filter according to the present invention has better performance than that of the conventional hybrid STBC scheme using the linear filter.

In addition, it can be under stood that, even in a channel environment having a high fading speed, the performance of the hybrid STBC scheme according to the present invention do not greatly deteriorate unlike the conventional hybrid STBC scheme. Therefore, the hybrid STBC scheme according to the present invention has a stable performance.

Accordingly, in a hybrid STBC scheme using a nonlinear DFB filter instead of a conventional linear filter which are used in a hybrid STBC scheme, that is, a combination of a spatial division multiplexing (SDM) scheme and a STBC scheme, a previous-stage remaining signal is detected, and inter-symbol interference (ISI) is minimized by applying the previous-stage remaining signal to a current-stage signal, so that performance can improved.

In addition, the hybrid STBC scheme can be applied to a time varying channel fading environment as well as a quasi-static channel environment. In addition, even in a channel environment having a high fading speed, the performance of the hybrid STBC scheme according to the present invention do not greatly deteriorate unlike the conventional hybrid STBC scheme. Therefore, the hybrid STBC scheme according to the present invention has a stable performance.

According to the simulation result for the hybrid STBC scheme, a gain of about 3 dB can be obtained in channel environments having a FER frequency efficiency of 2 and 3 Bps/Hz in the same condition. While the present invention has been particularly shown and described with reference to exemplary embodiments thereof, it will be understood by those of ordinary skill in the art that various changes in form and details may be made therein without departing from the spirit and scope of the present invention as defined by the following claims.

We claim:

1. A hybrid space time block codes (STBC) receiver for detecting a signal transmitted by a transmitter having a convolutional encoder, a bit interleaver, a mapper, a serial-to-parallel converter, and two space time block code (STBC) modules, wherein the receiver uses a non-linear decision feedback (DFB) filter.

2. The hybrid space time block codes (STBC) receiver according to claim 1, wherein the nonlinear DFB filter is represented by the following Equation.
W_{DFB}ⁱ=H*(HᵢHᵢ*+g(ê)+σₙ²I)⁻¹
